(19) United States
(12) Patent Application Publication
(10) Pub. No.: US 2019/0084146 A1
(43) Pub. Date: Mar. 21, 2019

(54) Drill Bit Clip

(71) Applicant: Lech Boltryk, Sierra Vista, AZ (US)

(72) Inventor: Lech Boltryk, Sierra Vista, AZ (US)

(21) Appl. No.: 16/128,088

(22) Filed: Sep. 11, 2018

Related U.S. Application Data
(60) Provisional application No. 62/559,717, filed on Sep. 18, 2017.

(51) Int. Cl. B25H 3/00

(52) U.S. Cl. CPC B25H 3/003

(57) ABSTRACT

The drill bit clip is a holder for various drill bits. The clip includes orifices on the body to accommodate drill bits and the body can be detachably mounted to the body of a drill. The two ends of the clip body provide additional support to provide secure attachment of the device on the drill so that the user can efficiently and conveniently change drill bits. The clip device includes various embodiments of the orifices that allow the user to take and hold a wide range of drill bits to the job site.

The current application claims a priority to the U.S. Provisional Patent application Ser. No. 62/559,717 filed on Sep. 18, 2017.

### FIELD OF THE INVENTION

The present invention relates generally to power tools and power tool accessories.

More specifically, the present invention relates to a drill bit carrying clip that can be detachably mounted to the body of a power drill to allow a user to efficiently and conveniently change the drill bits.

### BACKGROUND OF THE INVENTION

Power tools are essential in any kind of construction project. From building a bird house to assembling a house foundation, power tools facilitate the construction process and speed up the labor. Drills are particularly essential power tools to have in any construction project. Drills allow the user to perform a wide range of activities: from making a hole or orifice on a piece of material to sanding or even engraving. Most drills comprise a body which houses the electrical components of the drill as well as the power components. In the front of the body of the drill there is a section which receives a drill bit. The drill bits are cutting tools used to remove material to create holes. Other drill bit attachments also allow a user to use the power drill as screw drivers. These drill bits usually come in a separate container which is not part of the body of the power drill. The user often has to manually remove the drill bit from its container and inserts it into the body of the power drill. It is often the case for the user to utilize various drill bits of different shapes and sizes to perform different activities. Unfortunately, many users find themselves losing the drill bits as it is cumbersome to take the drill bit out of the container and putting the drill bit back afterwards. Many users find themselves placing the drill bit on a surface for later collection. But, after a long time of hard work it is easy to forget about the misplaced drill bits and many users end up losing them that way. Now, there are some drill bit holders which attach to the body of the power drill to allow the user to easily replace the drill bits and store them away while the drill bits are not being used. However, most of these drill bit holders do not allow the user to easily move the holder around the body of the power drill for comfort to the user. In addition, most of the drill bit holders do not fit most of the power drill designs and sizes. Thus, a drill bit carrying clip which can be easily mounted onto the body of a power drill and can hold various sizes and designs of drill bits is beneficial and necessary.

An objective of the present invention is to provide a drill bit carrying clip which can be mounted on the body of the power drill. A drill bit carrying clip which can be mounted on the body of the power drill is beneficial as it allows the user to easily reach and replace the different drill bits whenever needed without having to move. Another objective of the present invention is to provide a drill bit carrying clip which can hold drill bits of various sizes and designs. Another objective of the present invention is to provide a drill bit carrying clip which can be easily mounted and removed from the body of the drill without having to use any tools. Additional advantages of the present invention will be set forth in part in the detailed description that follows, and in part will be obvious from the detailed description or may be learned by practice of the present invention. Additional advantages of the invention may be realized and attained by means of the instrumentalities and combinations particularly pointed out in the detailed description of the present invention. Further benefits and advantages of the embodiments of the present invention will become apparent from consideration of the following detailed description given with reference to the accompanying drawings, which specify and show preferred embodiment of the present invention.

### SUMMARY OF THE INVENTION

The present invention is a drill bit carrying clip which is mounted onto the body of a power drill and holds various drill bits of different sizes and designs. The drill bit carrying clip can be easily mounted and removed from the body of the drill without having to use any kind of tool. The drill bit carrying clip can fit various drill sizes and shapes and allows a user to easily reach and replace different drill bits without having to move to get the different drill bits from their containers. The drill bit carrying clip may further comprise different designs to allow the user to mount various drill bits and sockets.

### BRIEF DESCRIPTION OF THE DRAWINGS

FIG. 1 is a perspective view of the preferred embodiment of the present invention showing the drill bit clip. The first end and second end of the drill bit clip are shown.

FIG. 2 is a top view of the preferred embodiment of the present invention showing the drill bit clip. The plurality of orifices is shown on the body of the drill bit clip.

FIG. 3 is a perspective view of an alternate embodiment of the present invention showing the drill bit clip. The first end and second end are shown with a first and second protrusion respectively.

FIG. 4 is a top view of an alternate embodiment of the present invention showing the drill bit clip. The first protrusion and second protrusion on the first end and second end of the drill bit clip are shown respectively.

FIG. 5 is a perspective view of an alternate embodiment of the present invention showing the drill bit clip.

FIG. 6 is a top view of an alternate embodiment of the present invention showing the drill bit clip. An alternate design of the plurality of orifices is shown.

FIG. 7 is a perspective view of an alternate embodiment of the present invention showing the drill bit clip. The plurality of protrusions is shown positioned in a linear pattern along the first surface on the body of the drill bit clip.

FIG. 8 is a top view of an alternate embodiment of the present invention showing the drill bit clip. The body of the drill bit clip is shown in a thinner embodiment with the plurality of protrusions positioned on the first surface.

FIG. 9 is a top view of an alternate embodiment of the present invention showing the drill bit clip. A ring is shown positioned in the plurality of orifices on the body of the drill bit clip.

FIG. 10 is a left view of the alternate embodiment of the present invention showing the drill bit clip holding a plurality of drill bits.

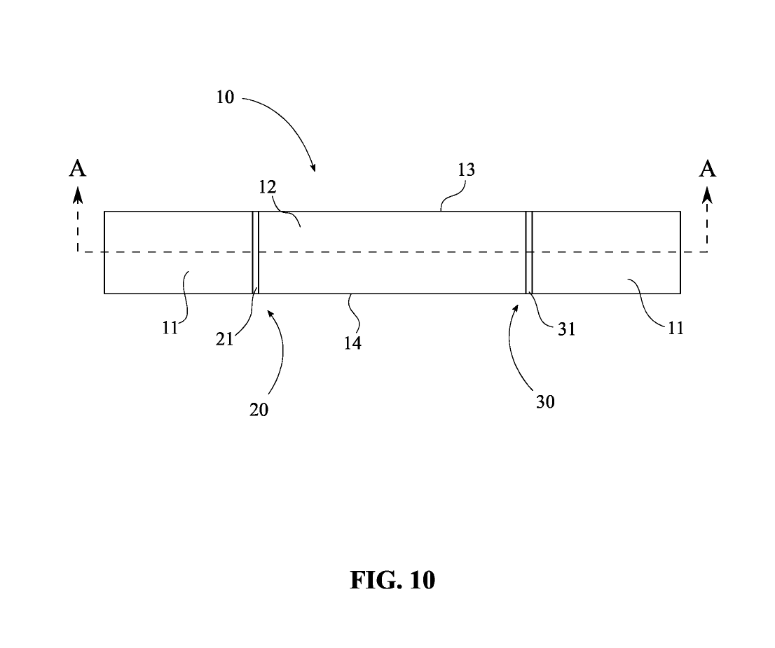

FIG. 11 is a sectional view of the alternate embodiment of the present invention taken about A-A in FIG. 10, showing a ring shown positioned in the plurality of orifices on the body of the drill bit clip.

FIG. 12 is a top sectional view of an alternate embodiment of the present invention taken about A-A in FIG. 10, showing the magnet positioned in the plurality of orifices on the body of the drill bit clip.

FIG. 13 is a perspective view of the alternate embodiment of the present invention showing the magnet positioned in the plurality of orifices on the body of the drill bit clip.

FIG. 14 is a front view of the alternate embodiment of the present invention showing the drill bit clip.

FIG. 15 is a left sectional view of the alternate embodiment of the present invention taken about B-B in FIG. 14, showing the magnet positioned in the plurality of orifices on the body of the drill bit clip.

### DETAIL DESCRIPTIONS OF THE INVENTION

All illustrations of the drawings are for the purpose of describing selected versions of the present invention and are not intended to limit the scope of the present invention.

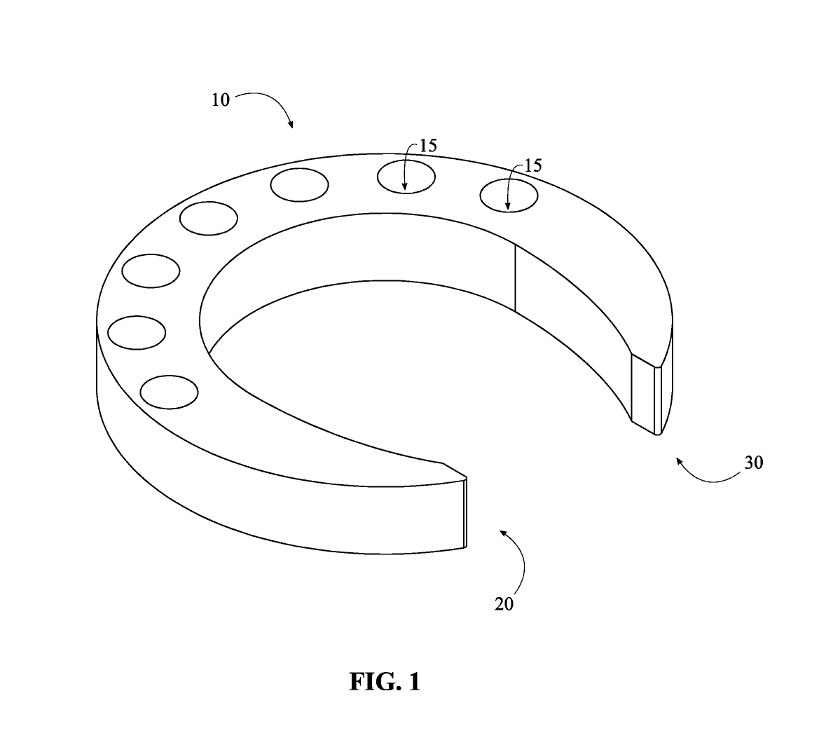

The present invention is a drill bit carrying clip which can be mounted on the body of a power drill. The drill bit clip holds a plurality of drill bits and allows a user to easily reach and replace the different drill bits without having to move to get the drill bits from a container. As can be seen in FIG. 1, in the preferred embodiment of the present invention, the drill bit carrying clip comprises a curved body 10, a first end 20, a second end 30, and a plurality of orifices 15. The curved body 10 provides a secure and efficient mounting mechanism for the user to detachably attach the drill bit carrying clip through the first end 20 and the send end 30 to various power drills the user chooses to. The plurality of orifices 15 allows the user to hold a plurality of drill bits that can be used for different types of work activities using the power drill. In the preferred embodiment of the present invention, the curved body 10 is an elongated, curved body around a center axis which forms a C-shape.

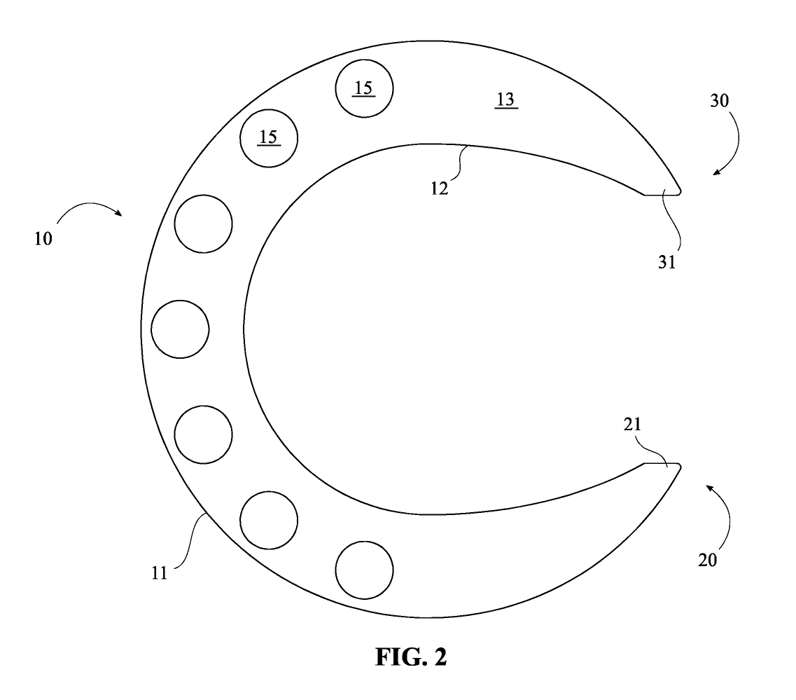

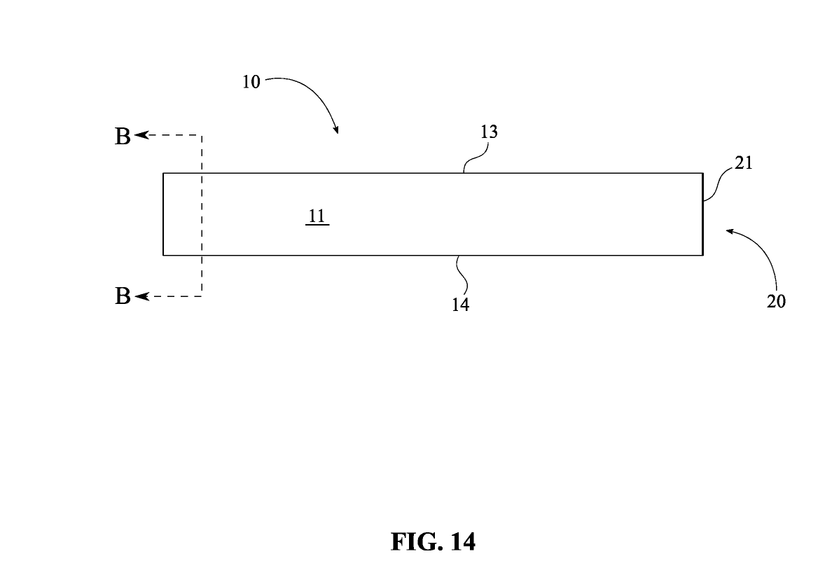

As seen in FIGS. 2 and 14, the curved body 10 comprises a first surface 11, a second surface 12, a front side 13, and a back side 14. The second surface 12 is the concave surface of the curved body 10, while the first surface 11 is the convex surface of the curved body 10. The second surface 12 is configured to receive a drill body of a power drill. When the present invention is mounted to the body of the power drill, the second surface 12 is securely attached on the drill body. The first surface 11 is opposite the second surface 12 along the curved body 10. The first surface 11 is the surface facing away from the body of the drill. In the preferred embodiment of the present invention, each of the plurality of orifices transverses through the front side 13 and the back side 14 of the curved body 10 of the drill bit carrying clip. The curved body 10 comprises a rectangular cross-section with a width which is longer than the width of most drill bits and a depth which is shorter than the length of most drill bits. In alternate embodiment of the present invention, the width of the curved body 10 may be shorter than the width of drill bits.

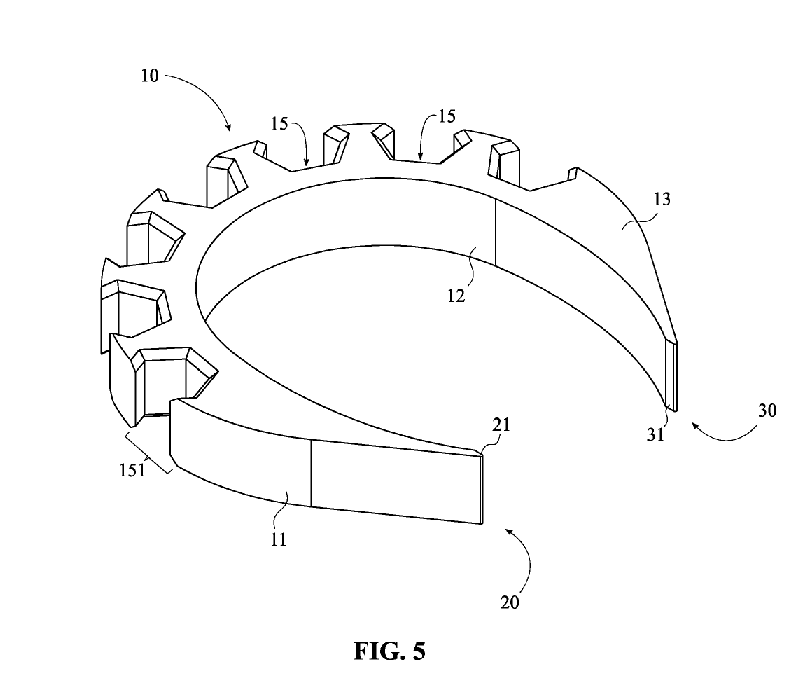

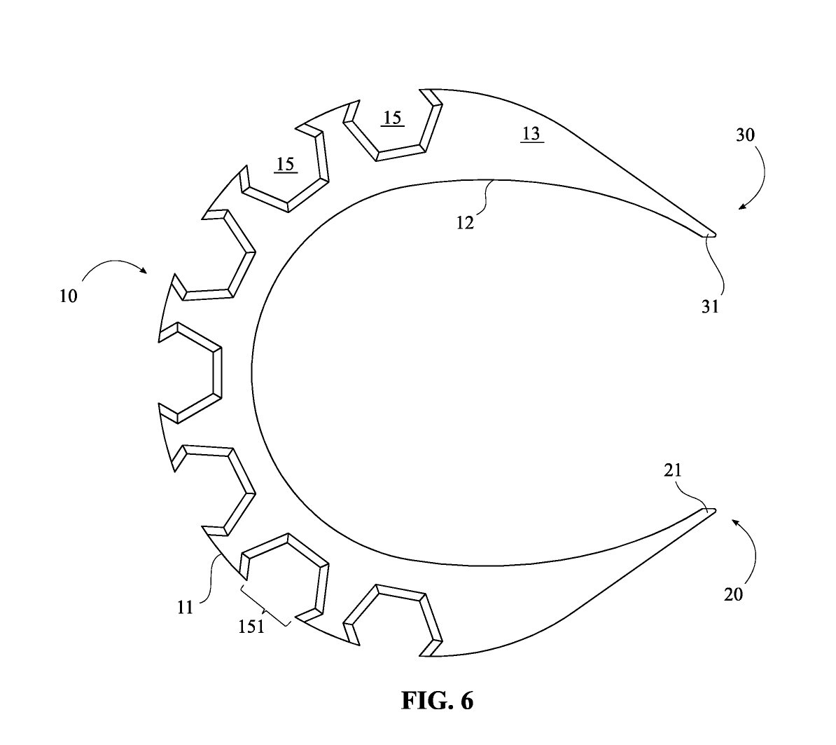

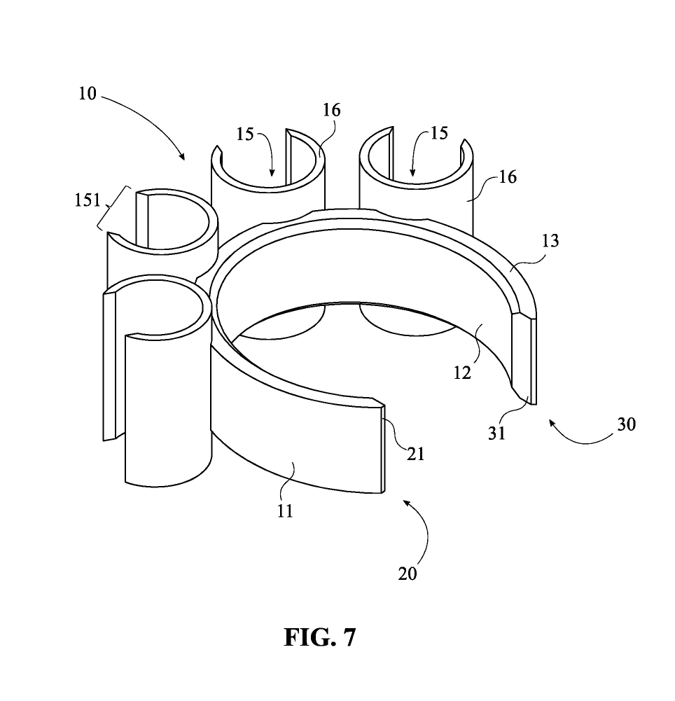

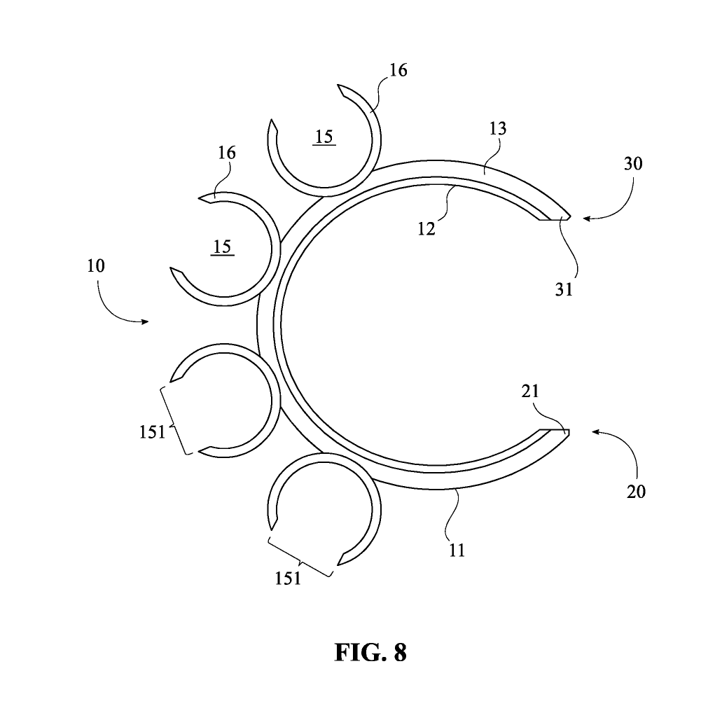

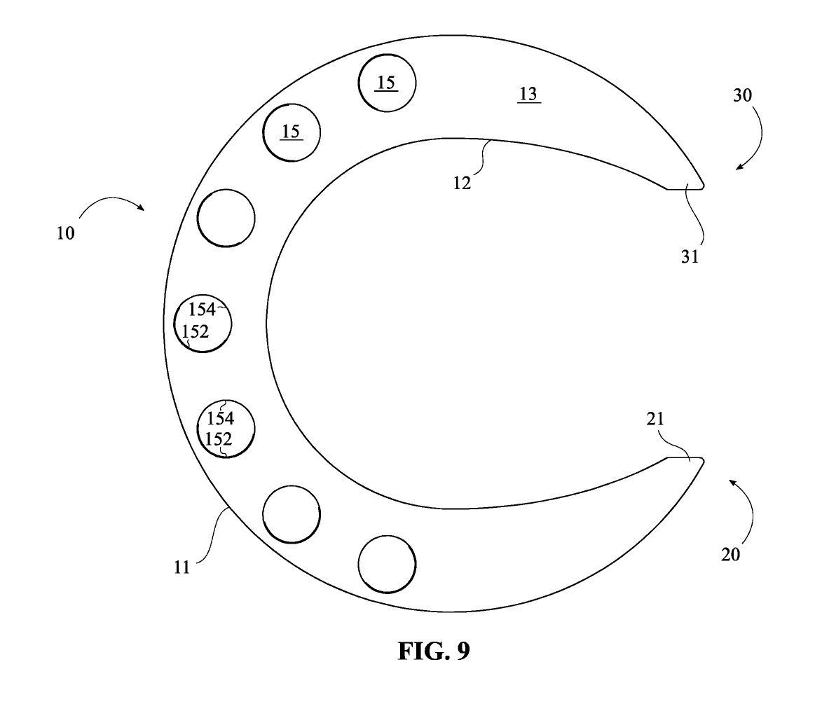

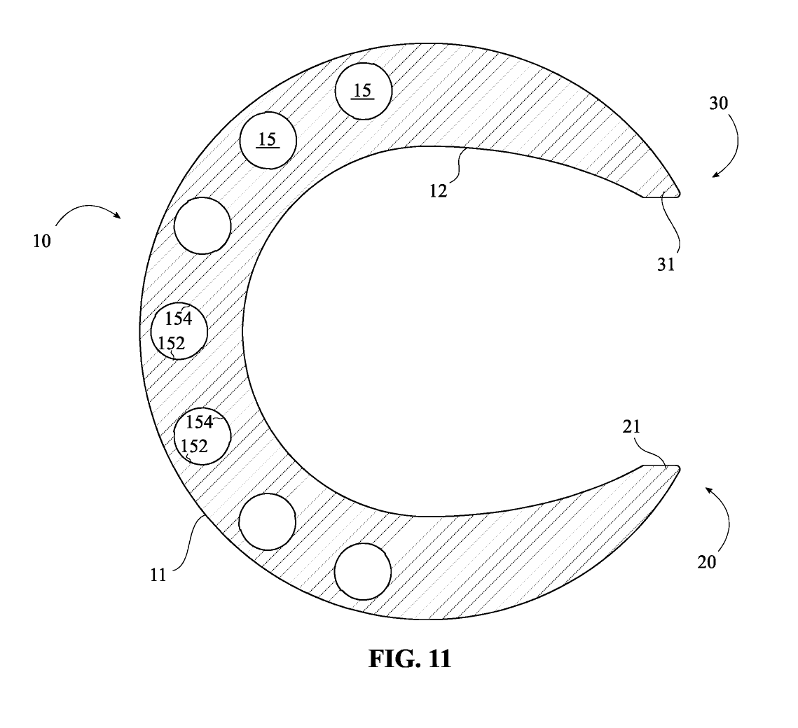

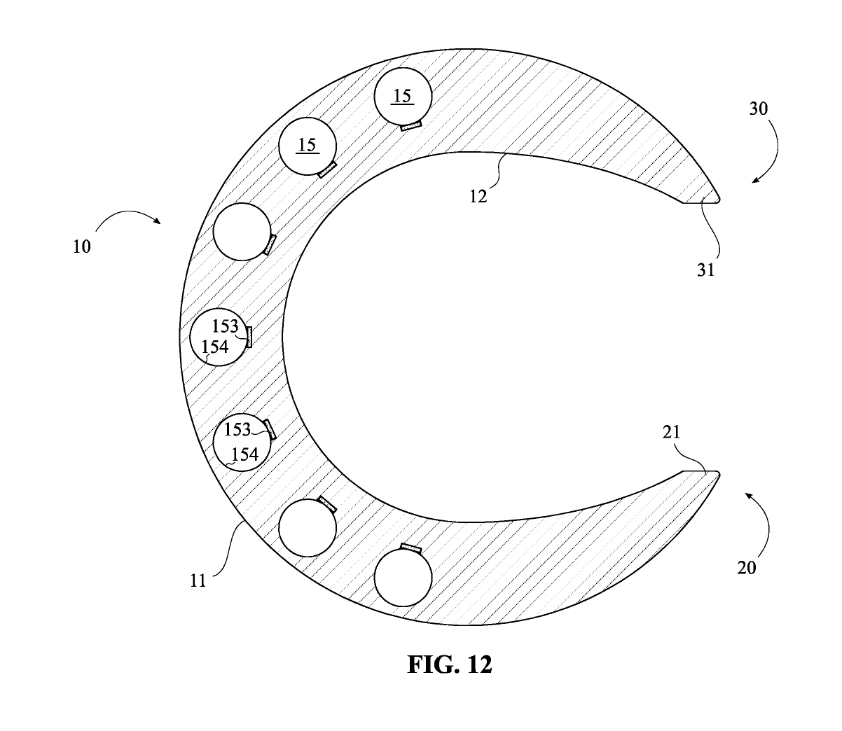

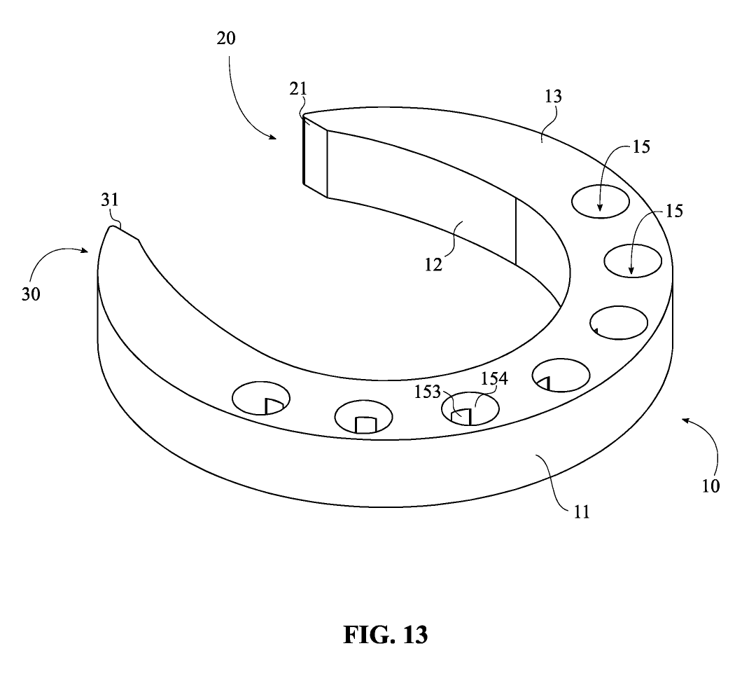

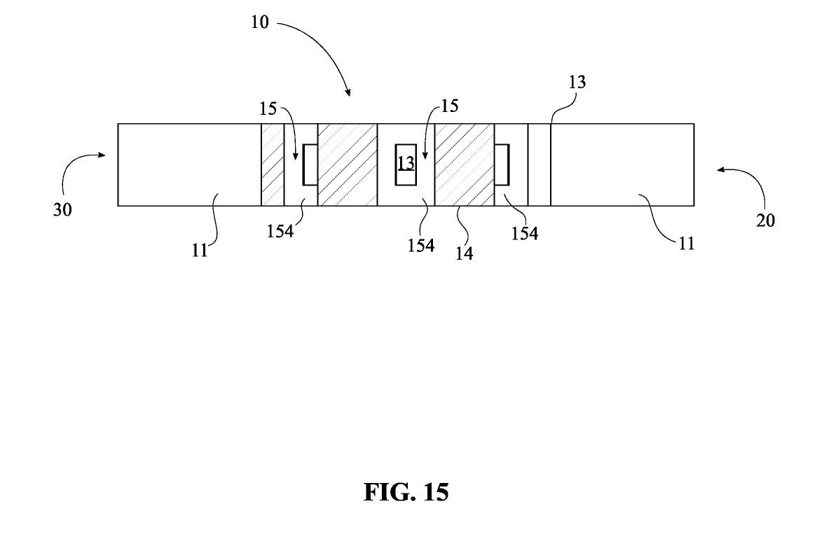

As can be seen in FIGS. 1-4, 9, 11-13, and 15, each of the plurality of orifices 15 receives the body of a drill bit and holds drill bit while the user utilizes the power drill. The plurality of orifices 15 comprises a number of orifices being distributed across the curved body 10 and positioned in a radial pattern along the curved body 10 of the drill bit clip. In the preferred embodiment of the present invention, each of the plurality of orifices 15 is a circular through hole, traversing through the curved body 10 from the front side 13 to the back side 14 of the curved body 10. Additionally, the plurality of the orifices is oriented perpendicular to the front side 13 and the back side 14 of the curved body 10, thus allowing the user to efficiently and conveniently attach or detach a drill bit to the present invention. As can be seen in FIGS. 1-4, 9, and 11-13, in the preferred embodiment of the present invention, each of the plurality of orifices 15 is a circular through hole in circular shape with a diameter which matches the outer diameter of the drill bit desired to be held by user. In one embodiment of the present invention, as seen in FIGS. 5-6, the plurality of orifices 15 comprises a hexagonal or similar shape to receive different shapes of drill bits. Each of the plurality of orifices 15 is a hexagonal or similarly shaped through hole, traversing through the front side 13 and the back side 14 of the curved body 10. Additionally, the plurality of orifices 15 is oriented perpendicular to the front side 13 and the back side 14 of the curved body 10. Furthermore, each of the plurality of orifices 15 in turn comprises a distal aperture 151, which is positioned opposite the first surface 11 of the curved body 10 and allows the user to mount the plurality of drill bits vertically on the plurality of orifices 15. In another embodiment of the present invention, as seen in FIGS. 7-8, the plurality of orifices 15 is formed by a plurality of protrusions positioned in a circular pattern against the first surface 11 of the curved body 10. Additionally, each of the plurality of orifices 15 is a circular through hole and oriented perpendicular to the front side 13 and the back side 14 of the curved body 10. In one embodiment of the present invention, as seen in FIGS. 9 and 11, each of the plurality of orifices 15 comprises a ring 152 and an inner surface 154. The ring 152 is semi-circular in shape and terminally connected to the inner surface 154 for each of the plurality of orifices 15. The ring 152 allows the user efficiently and securely attach/detach a drill bit in each of the plurality of orifices 15 so that the drill bit does not vibrate or fall off when the user is using the power drill. In another embodiment of the present invention, as seen in FIGS. 12-15, each of the plurality of orifices 15 comprises a magnet 153 and the inner surface 154. The magnet 153 is terminally connected to the inner surface 154 of each of the plurality of orifices 15 and may comprise, but is not limited to, a rectangular shape. The magnet 153 allows the user efficiently and firmly attach/detach a drill bit in each of the plurality of orifices 15 so that the drill bit does not vibrate or falls off when the user is using the power drill.

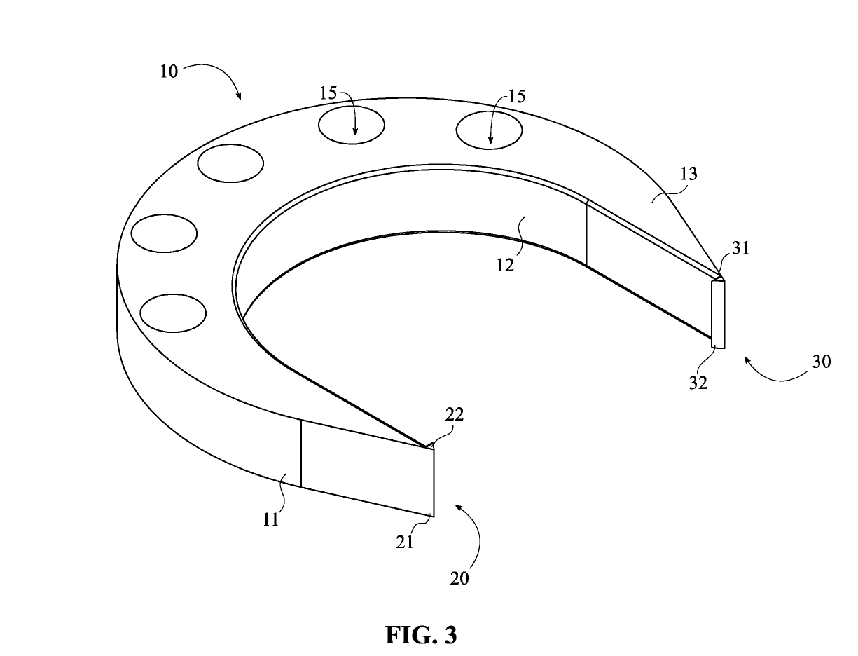

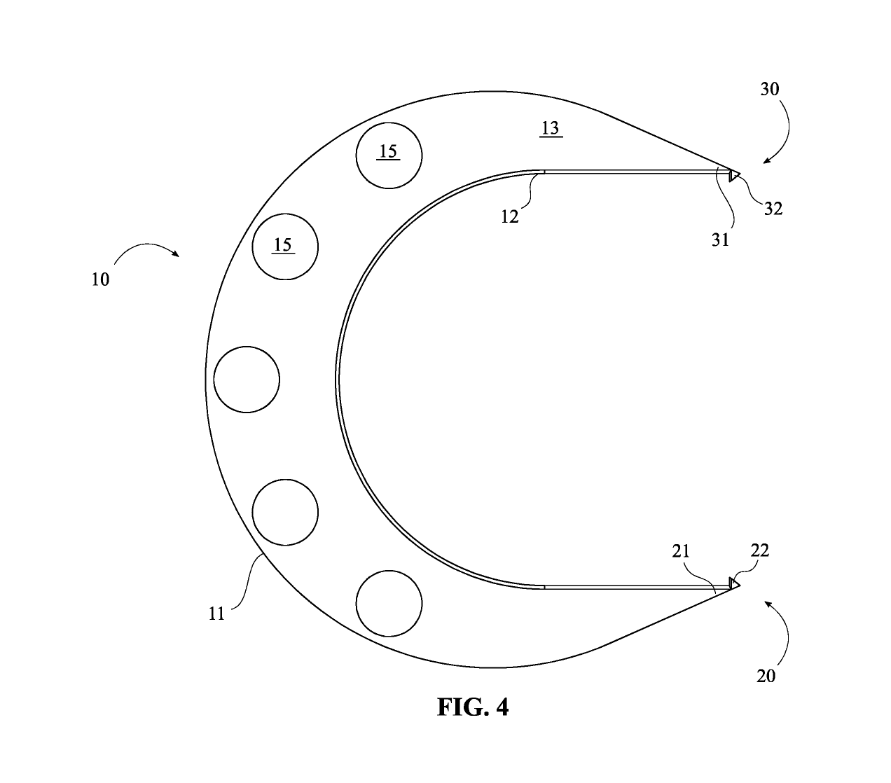

As can be seen in FIGS. 1 and 2, the first end 20 and second end 30 of the present invention are terminally positioned on the end of the curved body 10 of the drill bit carrying clip and press against the body of the power drill to securely hold the curved body 10 of the drill bit carrying clip onto the body of the drill. In the one embodiment of the present invention as seen in FIGS. 1-9, and 11-13, the first end 20 comprises a first protrusion 21, and second end 30 comprises a second protrusion 31. In some embodiments, both the first protrusion 21 and the second protrusion 31 are curved, pointed protrusions, which can have various shapes and/or be formed into sharp bodies at the ends to allow the user to securely attach the present invention to the body of the power drill. In another embodiment of the present invention as seen in FIGS. 3-4, the first end 20 comprises a first lip 22, and second end 30 comprises a second lip 32. Both first lip 22 and the second lip 32 are located at the pointed end and can be various shapes and/or formed into end grip bodies to increase the surface area pressed against the body of the power drill.

To use the preferred embodiment of the present invention, the use acquires a drill bit carrying clip and mount the present invention on the top of the body of the power drill the user chooses. The user then chooses a plurality of drill bits and inserts into the plurality of orifices 15 of the curved body 10. To mount the drill bit clip onto the body of the drill, the user positions the drill bit clip on the position desired on the body of the drill and presses the body of the drill bit clip against the body of the drill. The first end 20 and second end 30 of the drill bit clip snap onto the curved body 10 of the drill and press against the outer surfaces of the body of the drill to securely hold the curved body 10 of the drill bit clip onto the body of the drill. The user can then utilize the drill for various activities and remove and replace the different drill bits placed on the plurality of orifices 20 on the curve body 10 of the drill bit clip by sliding the body of the drill bit into the plurality of orifices 15 and pulling the body of the drill bits out of the plurality of orifices 15 on the curved body 10 of the drill bit clip. The user can move the drill bit clip to a different position on the body of the drill easily by just pulling the curved body 10 of the drill bit clip away from the body of the drill and mounting the present invention onto a new position.

Although the invention has been explained in relation to its preferred embodiment, it is to be understood that many other possible modifications and variations can be made without departing from the spirit and scope of the invention.

What is claimed is:

1. A drill bit carrying clip and being mounted on the body of a power drill comprising:
a curved body;
a first end;
a second end;
a plurality of orifices;
the curved body comprising a first surface, a second surface, a front side, and a back side;
the second surface being configured to receive a drill body of a power drill;
the first surface being opposite the second surface along the curved body;
the plurality of orifices being distributed across the curved body; and
the first end and the second end being terminally positioned opposite each other along the curved body.

2. The drill bit carrying clip being mounted on the body of a power drill as claimed in claim 1 comprising:
the plurality of orifices traversing through the front side and the back side of the curved body; and
the plurality of orifices being oriented perpendicular to the front side and the back side of the curved body.

3. The drill bit carrying clip being mounted on the body of a power drill as claimed in claim 1 comprising:
the curved body being C-shaped.

4. The drill bit carrying clip being mounted on the body of a power drill as claimed in claim 1 comprising:
each of the first end and the second end comprising a lip.

5. The drill bit carrying clip being mounted on the body of a power drill as claimed in claim 1 comprising:
each of the first end and the second end comprising a protrusion.

6. The drill bit carrying clip being mounted on the body of a power drill as claimed in claim 1 comprising:
each of the plurality of orifices being a circular through hole;
the circular through hole being positioned against the first surface of the curved body;
the plurality of orifices being oriented perpendicular to the front side and the back side of the curved body; and
the circular through hole comprising a distal aperture; and
the distal aperture being positioned opposite the first surface of the curved body.

7. The drill bit carrying clip being mounted on the body of a power drill as claimed in claim 1 comprising:
each of the plurality of orifices being a hexagonal through hole;
each hexagonal through hole traversing through the front side and the back side of the curved body;
the plurality of orifices being oriented perpendicular to the front side and the back side of the curved body;
each hexagonal through hole comprising a distal aperture; and
the distal aperture traversing through the first surface of the curved body, from the front side to the back side of the curved body.

8. The drill bit carrying clip being mounted on the body of a power drill as claimed in claim 1 comprising:
each of the plurality of orifices comprising a ring and an inner surface; and
the ring being semi-circular and terminally connected to the inner surface for each of the orifices.

9. The drill bit carrying clip being mounted on the body of a power drill as claimed in claim 1 comprising:
each of the plurality of orifices comprising a magnet; and
the magnet being terminally connected to an inner surface of the orifice.

10. The drill bit carrying clip being mounted on the body of a power drill as claimed in claim 1 comprising:
the curved body comprising a plurality of protrusions;
the plurality of protrusions being terminally positioned across and tangential to the first surface of the curved body;
each of the plurality of protrusions comprising a circular orifice;
the circular orifice comprising a distal aperture; and
the distal aperture being positioned opposite the first surface of the curved body.

11. A drill bit carrying clip and being mounted on the body of a power drill comprising:
a curved body;
a first end;
a second end;
a plurality of orifices;
the curved body being C-shaped;
the curved body comprising a first surface, a second surface, a front side, and a back side;
the second surface being configured to receive a drill body of a power drill;
the first surface being opposite the second surface along the curved body;
the plurality of orifices being distributed across the curved body;
the plurality of orifices traversing through the front side and the back side of the curved body; and
the first end and the second end being terminally positioned opposite each other along the curved body.

12. The drill bit carrying clip being mounted on the body of a power drill as claimed in claim 11 comprising:
the plurality of orifices traversing through the front side and the back side of the curved body; and
the plurality of orifices being oriented perpendicular to the front side and the back side of the curved body.

13. The drill bit carrying clip being mounted on the body of a power drill as claimed in claim 11 comprising:
each of the first end and the second end comprising a lip.

14. The drill bit carrying clip being mounted on the body of a power drill as claimed in claim 11 comprising:
each of the first end and the second end comprising a protrusion.

15. The drill bit carrying clip being mounted on the body of a power drill as claimed in claim 11 comprising:
each of the plurality of orifices being a circular through hole;
the circular through hole being positioned against the first surface of the curved body;
the plurality of orifices being oriented perpendicular to the front side and the back side of the curved body;
the circular through hole comprising a distal aperture; and
the distal aperture being positioned opposite the first surface of the curved body.

16. The drill bit carrying clip being mounted on the body of a power drill as claimed in claim 11 comprising:
each of the plurality of orifices being a hexagonal through hole;
each hexagonal through hole traversing through the front side and the back side of the curved body;
the plurality of orifices being oriented perpendicular to the front side and the back side of the curved body;
each hexagonal through hole comprising a distal aperture; and
the distal aperture traversing through the first surface of the curved body, from the front side to the back side of the curved body.

17. The drill bit carrying clip being mounted on the body of a power drill as claimed in claim 11 comprising:
each of the plurality of orifices comprising a ring and an inner surface; and
the ring being semi-circular and terminally connected to the inner surface for each of the orifices.

18. The drill bit carrying clip being mounted on the body of a power drill as claimed in claim 11 comprising:
each of the plurality of orifices comprising a magnet; and
the magnet being terminally connected to an inner surface of the orifice.

19. The drill bit carrying clip being mounted on the body of a power drill as claimed in claim 11 comprising:
the curved body comprising a plurality of protrusions;
the plurality of protrusions being terminally positioned across and tangential to the first surface of the curved body;
each of the plurality of protrusions comprising a circular orifice;
the circular orifice comprising a distal aperture; and
the distal aperture being positioned opposite the first surface of the curved body.

20. A drill bit carrying clip and being mounted on the body of a power drill comprising:
a curved body;
a first end;
a second end;
a plurality of orifices;
the curved body being C-shaped;
the curved body comprising a first surface, a second surface, a front side, and a back side;
the second surface being configured to receive a drill body of a power drill;
the first surface being opposite the second surface along the curved body;
the plurality of orifices being distributed across the curved body;
the plurality of orifices traversing through the front side and the back side of the curved body;
the plurality of orifices being oriented perpendicular to the front side and the back side of the curved body; and
the first end and the second end being terminally positioned opposite each other along the curved body.
